(19) United States
(12) Patent Application Publication
(10) Pub. No.: US 2021/0230385 A1
(43) Pub. Date: Jul. 29, 2021

(54) Prepreg, Fiber-Reinforced Composite Resin Molded Article, Method for Producing Tubular Molded Article, Epoxy Resin Composition, and Tubular Molded Article

(71) Applicant: Mitsubishi Chemical Corporation, Tokyo (JP)

(72) Inventors: Nao Kawamura, Tokyo (JP); Takuya Teranishi, Tokyo (JP)

(73) Assignee: Mitsubishi Chemical Corporation, Tokyo (JP)

(21) Appl. No.: 17/227,645

(22) Filed: Apr. 12, 2021

Related U.S. Application Data
(63) Continuation of application No. PCT/JP2019/040933, filed on Oct. 17, 2019.

(30) Foreign Application Priority Data
Oct. 17, 2018 (JP) 2018-195636

(51) Int. Cl. C08J 5/24; C08K 5/21; B29C 70/44

(52) U.S. Cl. CPC C08J 5/243; C08K 5/21; B29K 2063/00; C08J 2363/00; C08J 2463/00; B29C 70/446

(57) ABSTRACT

Provided is a prepreg that can be cured in a short time even at a low temperature, and can obtain a fiber-reinforced composite resin molded article having excellent mechanical properties such as flexural modulus, bending strength, and breaking strain, and excellent heat resistance. The prepreg of the embodiment includes an epoxy resin composition and a reinforcing fiber, in which the epoxy resin composition includes a component (A): an oxazolidone epoxy resin, a component (B): a novolac epoxy resin, a component (C): a urea compound, and a component (D): a curing agent, and with respect to a total mass of all epoxy resins included in the epoxy resin composition, a content of the component (A) is 40% to 70% by mass and a content of the component (B) is 15% to 40% by mass.

This application is a continuation application of International Application No. PCT/JP2019/040933, filed on Oct. 17, 2019, which claims the benefit of priority of the prior Japanese Patent Application No. 2018-195636, filed on Oct. 17, 2018, the content of which is incorporated herein by reference.

### TECHNICAL FIELD

The present invention relates to a prepreg, a fiber-reinforced composite resin molded article, a method for producing a tubular molded article, an epoxy resin composition, and a tubular molded article.

### BACKGROUND ART

A fiber-reinforced composite resin molded article, which is one of fiber-reinforced composite materials, is light-weight, has high strength, and has high rigidity, so that the fiber-reinforced composite resin molded article has been widely used from sports/leisure applications to industrial applications such as automobiles and aircraft. Among the fiber-reinforced composite resin molded bodies, a fiber-reinforced composite resin tubular body has been widely used for sports/leisure applications such as fishing poles, golf club shafts, ski poles, and bicycle frames.

As a method for producing the fiber-reinforced composite resin molded article, there is a method of using an intermediate material in which a reinforcing material made of long fibers such as reinforcing fibers is impregnated with a matrix resin, that is, using a prepreg. According to this method, there is an advantage that the content of the reinforcing fiber in the fiber-reinforced composite resin molded article can be easily controlled and the content thereof can be designed to be higher.

Examples of a specific method for obtaining the fiber-reinforced composite resin molded article from the prepreg include a molding method using an autoclave, press molding, internal pressure molding, and oven molding. In any one of these methods, usually, in a case where two or more prepregs are laminated, molded into a desired shape, and then heat-cured, it takes approximately 2 to 6 hours to cure the laminate under the condition of approximately 160° C. or higher. That is, high temperature and long-term treatment are required for the production of the fiber-reinforced composite resin molded article.

In order to improve the molding cycle, it is required that molding can be performed at a relatively low temperature of approximately 100° C. to 140° C. in a short time of approximately several minutes to several tens of minutes.

Further, in order to avoid deformation in a case of taking out the fiber-reinforced composite resin molded article from the mold, it is required for the fiber-reinforced composite resin molded article to have heat resistance. Specifically, it is desired that the glass transition temperature of the cured prepreg, that is, the fiber-reinforced composite resin molded article, is higher than the temperature of the mold during molding.

As the matrix resin used for the prepreg, an epoxy resin composition having excellent mechanical properties, heat resistance, and handleability has been widely used. In particular, it is required for epoxy resin compositions used for sports/leisure applications, industrial applications, and the like to have both breaking strain and heat resistance. In order to improve the breaking strain of the epoxy resin composition, for example, it is effective to reduce the crosslink density of the epoxy resin composition. However, in a case where the crosslink density of the epoxy resin composition is reduced, the glass transition temperature of the cured product is lowered, and the heat resistance tends to be lowered. As the glass transition temperature of a cured product of the epoxy resin composition is lowered, the glass transition temperature of the fiber-reinforced composite resin molded article is also lowered. Therefore, it is difficult to achieve both the breaking strain and the heat resistance of the fiber-reinforced composite resin molded article.

Accordingly, an epoxy resin composition or a prepreg, which can be cured in a short time even at a low temperature so as to enable to perform high-cycle molding and from which a fiber-reinforced composite resin molded article having excellent mechanical properties, especially excellent breaking strain and heat resistance, is obtained has been required.

As a prepreg for a golf shaft having excellent strength, Patent Document 1 discloses a prepreg that an epoxy resin composition using, as a latent curing agent, dicyandiamide which has excellent breaking strain, and using, as a thermoplastic resin elastomer, polyvinyl formal is used as a matrix resin.

### CITATION LIST

### Patent Document

[Patent Document 1]
Japanese Unexamined Patent Application, First Publication No. 2015-12996

### SUMMARY OF INVENTION

### Technical Problem

The prepreg in which reinforcing fibers are impregnated into the epoxy resin composition, disclosed in Patent Document 1, requires a curing time of 2 hours at 130° C., and does not meet the above requirements.

One of objects of the present invention is to provide a prepreg that can be cured in a short time even at a low temperature, and can obtain a fiber-reinforced composite resin molded article having excellent mechanical properties such as flexural modulus, bending strength, and breaking strain, and excellent heat resistance; and a fiber-reinforced composite resin molded article having excellent mechanical properties such as flexural modulus, bending strength, and breaking strain, and excellent heat resistance.

### Solution to Problem

The embodiment has the following aspects.

[1] A prepreg comprising:

an epoxy resin composition; and

a reinforcing fiber,

wherein the epoxy resin composition includes the following component (A), component (B), component (C), and component (D),

component (A): an oxazolidone epoxy resin,

component (B): a novolac epoxy resin,

component (C): a urea compound, and

component (D): a curing agent, and

with respect to a total mass of all epoxy resins included in the epoxy resin composition, a content of the component (A) is 40% to 70% by mass and a content of the component (B) is 15% to 40% by mass.

[2] The prepreg according to [1],

wherein a mass ratio of the content of the component (A) to the content of the component (B) (content of component (A)/content of component (B)) in the epoxy resin composition is 1.2 or more.

[3] The prepreg according to [1] or [2],

wherein the component (B) has a structural unit derived from a structure represented by Formula (2).

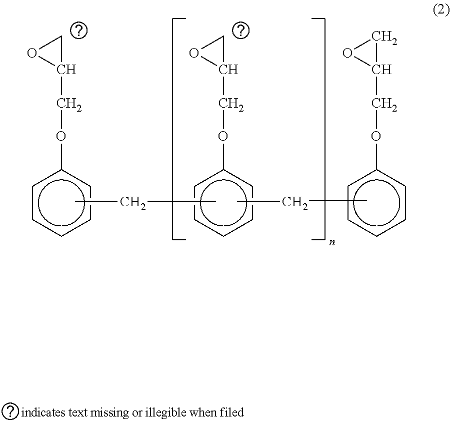

(in Formula (2), n represents an integer of 1 to 30)

[4] The prepreg according to any one of [1] to [3],

wherein the reinforcing fiber is a carbon fiber.

[5] The prepreg according to any one of [1] to [4],

wherein the component (D) is an amine curing agent.

[6] The prepreg according to any one of [1] to [5],

wherein the component (C) is phenyldimethylurea.

[7] The prepreg according to any one of [1] to [6],

wherein a content of the component (C) is 1 to 10 parts by mass with respect to the total mass (100 parts by mass) of all epoxy resins included in the epoxy resin composition.

[8] The prepreg according to any one of [1] to [7],

wherein a content of the component (D) is 2 to 15 parts by mass with respect to the total mass (100 parts by mass) of all epoxy resins included in the epoxy resin composition.

[9] A fiber-reinforced composite resin molded article, which is a cured product of a laminate in which two or more prepregs according to any one of [1] to [8] are laminated.

[10] A method for producing a tubular molded article, comprising:

a step of placing a tubular prepreg including a resin composition and a reinforcing fiber in a mold;

a step of heating the tubular prepreg at 130° C. or higher; and

a step of pressing the tubular prepreg against the mold by expanding a medium from an inside of the tubular prepreg, thereby molding a tubular molded article,

wherein the resin composition includes the following component (A),

component (B), and component (D),

component (A): an oxazolidone epoxy resin,

component (B): a novolac epoxy resin, and

component (D): a curing agent.

[11] The method for producing a tubular molded article according to [10],

wherein the tubular molded article has an annular curved portion, and

the method for producing a tubular molded article further includes a step of annularly bending the tubular prepreg.

[12] An epoxy resin composition comprising:

an epoxy resin; and

a curing agent,

wherein a glass transition point of the epoxy resin composition is 140° C. or higher,

in a case where the epoxy resin composition is heated at 130° C. to 150° C. to obtain a cured resin plate, a curing completion time in the following measuring method is 12 minutes or less, and

the cured resin plate has a bending strength of 174 MPa or more, a flexural modulus of 3.6 GPa or more, and a breaking strain of 9% or more.

(measuring method)

according to JIS K 6300, a change in torque value (N·m) at a die temperature of 140° C. is measured to obtain a torque-time curve; a time until an inclination of a tangent line of the obtained torque-time curve becomes 1/30 of a maximum value after the inclination reaches the maximum is defined as the curing completion time.

[13] The epoxy resin composition according to [12],

wherein the epoxy resin has a ring structure.

[14] The epoxy resin composition according to [12] or [13],

wherein the epoxy resin has a structural unit derived from a structure represented by Formula (2).

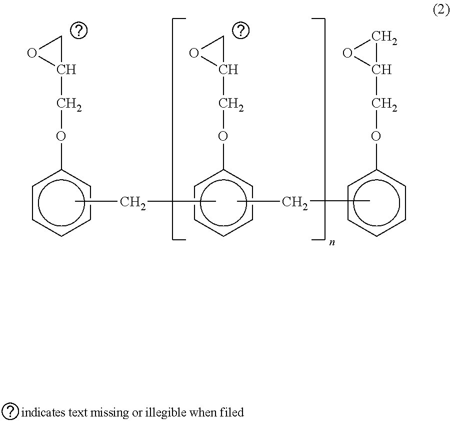

(in Formula (2), n represents an integer of 1 to 30)

[15] The epoxy resin composition according to any one of [12] to [14],

wherein the epoxy resin includes a urea compound.

[16] A tubular molded article having a curved portion, comprising:

a cured product of a resin composition; and a carbon fiber,

wherein the resin composition includes the following component (A), component (B), and component (D),

component (A): an oxazolidone epoxy resin,

component (B): a novolac epoxy resin, and

component (D): a curing agent.

### Advantageous Effects of Invention

The prepreg of the embodiment can be cured in a short time even at a low temperature, and can obtain a fiber-reinforced composite resin molded article having excellent mechanical properties such as flexural modulus, bending strength, and breaking strain, and excellent heat resistance.

The fiber-reinforced composite resin molded article of the embodiment has excellent mechanical properties such as flexural modulus, bending strength, and breaking strain, and excellent heat resistance.

### DESCRIPTION OF EMBODIMENTS

[Prepreg]

The prepreg of the embodiment comprises an epoxy resin composition and a reinforcing fiber.

<Epoxy Resin Composition>

The epoxy resin composition includes the following component (A), component (B), component (C), and component (D). Further, the epoxy resin composition may include a component (optional component) other than the component (A), the component (B), the component (C), and the component (D).

(Component (A))

The component (A) is an oxazolidone epoxy resin. The oxazolidone epoxy resin is an epoxy resin having an oxazolidone ring structure.

Since the epoxy resin composition includes the component (A), workability of the prepreg at normal temperature is improved. Further, heat resistance, breaking strain, and adhesiveness of the cured product of the epoxy resin composition (hereinafter, also referred to as a “resin cured product”) to the reinforcing fiber are improved, and a fiber-reinforced composite resin molded article having excellent heat resistance and breaking strain can be obtained.

In the present specification, the “normal temperature” means 30° C.

The oxazolidone ring structure is formed by an addition reaction of an isocyanate group and an epoxy group.

A method for producing the oxazolidone epoxy resin is not particularly limited, and for example, the oxazolidone epoxy resin can be obtained in a substantially theoretical amount by reacting an isocyanate compound and an epoxy resin in the presence of a catalyst used for forming an oxazolidone ring. It is preferable that the isocyanate compound and the epoxy resin are reacted in an equivalent ratio (isocyanate compound:epoxy resin) in a range of 1:2 to 1:10. In a case where the equivalent ratio of the isocyanate compound and the epoxy resin is within the above-described range, the heat resistance and water resistance of the resin cured product tend to be better.

The isocyanate compound used as a raw material for the component (A) is not particularly limited, but in order to incorporate the oxazolidone ring structure into the skeleton of the epoxy resin, an isocyanate compound having a plurality of isocyanate groups is preferable. Further, in order for the resin cured product to have high heat resistance, diisocyanate having a rigid structure is preferable.

Specific examples of the isocyanate compound include bifunctional isocyanate compounds such as methane diisocyanate, butane-1,1-diisocyanate, ethane-1,2-diisocyanate, butane-1,2-diisocyanate, trans-vinylene diisocyanate, propane-1,3-diisocyanate, butane-1,4-diisocyanate, 2-butene-1,4-diisocyanate, 2-methylbutene-1,4-diisocyanate, 2-methylbutane-1,4-diisocyanate, pentane-1,5-diisocyanate, 2,2-dimethylpentane-1,5-diisocyanate, hexane-1,6-diisocyanate, heptane-1,7-diisocyanate, octane-1,8-diisocyanate, nonane-1,9-diisocyanate, decane-1,10-diisocyanate, dimethylsilane diisocyanate, diphenylsilane diisocyanate, ω,ω′-1,3-dimethylbenzene diisocyanate, ω,ω′-1,4-dimethylbenzene diisocyanate, ω,ω′-1,3-dimethylcyclohexane diisocyanate, ω,ω′-1,4-dimethylcyclohexane diisocyanate, ω,ω′-1,4-dimethylnaphthalene diisocyanate, ω,ω′-1,5-dimethylnaphthalene diisocyanate, cyclohexane-1,3-diisocyanate, cyclohexane-1,4-diisocyanate, 3-isocyanatomethyl-3,5,5-trimethylcyclohexyl isocyanate, dicyclohexylmethane-4,4′-diisocyanate, 1,3-phenylene diisocyanate, 1,4-phenylene diisocyanate, 1-methylbenzene-2,4-diisocyanate, 1-methylbenzene-2,5-diisocyanate, 1-methylbenzene-2,6-diisocyanate, 1-methylbenzene-3,5-diisocyanate, diphenylether-4,4′-diisocyanate, diphenylether-2,4′-diisocyanate, naphthalene-1,4-diisocyanate, naphthalene-1,5-diisocyanate, biphenyl-4,4′-diisocyanate, 3,3′-dimethylbiphenyl-4,4′-diisocyanate, 2,3′-dimethoxybisphenyl-4,4′-diisocyanate, diphenylmethane-4,4′-diisocyanate, 3,3′-dimethoxydiphenylmethane-4,4′-diisocyanate, 4,4′-dimethoxydiphenylmethane-3,3′-diisocyanate, norbornene diisocyanate, diphenyl sulfate-4,4′-diisocyanate, and diphenylsulfon-4,4′-diisocyanate; trifunctional or higher functional isocyanate compounds such as polymethylene polyphenyl isocyanate and triphenylmethane triisocyanate; and multimers such as dimer and trimer of the above-described isocyanate compound, and blocked isocyanates and bisurethane compounds masked with alcohol or phenol. The isocyanate compound is not limited thereto.

One kind of these isocyanate compounds may be used alone, or two or more kinds thereof may be used in combination.

Among the above-described isocyanate compounds, from the viewpoint that the heat resistance of the resin cured product tends to be improved, a bifunctional isocyanate compound or a trifunctional isocyanate compound is preferable, a bifunctional isocyanate compound is more preferable, and a bifunctional isocyanate compound having a skeleton selected from isophorone, benzene, toluene, diphenylmethane, naphthalene, norbornene polymethylene polyphenylene polyphenyl, and hexamethylene is still more preferable.

In a case where the number of functional groups of the isocyanate compound is appropriately large, storage stability of the epoxy resin composition is unlikely to decrease. In a case where the number of functional groups of the isocyanate compound is appropriately small, the heat resistance of the resin cured product is unlikely to decrease.

As the epoxy resin used as a raw material for the component (A), various epoxy resins can be used, but in order to efficiently incorporate the oxazolidone ring structure into the skeleton of the epoxy resin, an epoxy resin having epoxy groups at both ends of the molecule is preferable.

Specific examples of the epoxy resin include epoxy resins derived from dihydric phenols such as bisphenol A, bisphenol F, bisphenol AD, bisphenol S, tetramethyl bisphenol A, tetramethyl bisphenol F, tetramethyl bisphenol AD, tetramethyl bisphenol S, tetrabromo bisphenol A, and biphenyl; epoxy resins derived from tris(glycidyloxyphenyl)alkanes and the like, such as 1,1,1-tris(4-hydroxyphenyl)methane, 1,1,1-tris(4-hydroxyphenyl)ethane, and 4,4-[1-[4-[1-(4-hydroxyphenyl)-1-methylethyl]phenyl]ethylidene] bisphenol; and epoxy resins derived from novolac such as phenol novolac, cresol novolac, and bisphenol A novolac. The epoxy resin is not limited thereto.

One kind of these epoxy resins may be used alone, or two or more kinds thereof may be used in combination.

As the epoxy resin, from the viewpoint that suppressing an excessive increase in the viscosity of the component (A), a bisphenol A epoxy resin, a bisphenol F epoxy resin, or a biphenyl epoxy resin is preferable.

As the isocyanate compound, an addition reaction product obtained by mixing and reacting one molecule of bifunctional isocyanate having a toluene skeleton such as tolylene diisocyanate (for example, 1-methylbenzene-2,4-diisocyanate, 1-methylbenzene-2,5-diisocyanate, 1-methylbenzene-2,6-diisocyanate, and 1-methylbenzene-3,5-diisocyanate) and two molecules of bisphenol A diglycidyl ether as the epoxy resin is particularly preferable from the viewpoint of improving the workability of the prepreg at normal temperature and the heat resistance of the resin cured product.

Examples of a commercially available product of the component (A) include AER 4152, AER 4151, LSA 3301, and LSA 2102 (all trade names, manufactured by Asahi Kasei Corporation); ACR 1348 (trade name, manufactured by ADEKA CORPORATION); DER (registered trademark; the same applies hereinafter) 852 and 858 (both trade names, manufactured by Dow Chemical Japan); TSR-400 (trade name, manufactured by DIC CORPORATION); and YD-952 (trade name, manufactured by Nippon Steel & Sumikin Chemical Co., Ltd.). All of these commercially available products are preferably used in the embodiment, but AER 4152 or TSR-400 is particularly preferable.

One kind of the component (A) may be used alone, or two or more kinds thereof may be used in combination.

With respect to the total mass (100% by mass) of all epoxy resins included in the epoxy resin composition, the content of the component (A) is 40% by mass or more, preferably 41% by mass or more and more preferably 42% by mass or more. Further, with respect to the total mass (100% by mass) of all epoxy resins included in the epoxy resin composition, the content of the component (A) is 70% by mass or less, preferably 65% by mass or less, more preferably 60% by mass or less, and particularly preferably 55% by mass or less.

With respect to the total mass (100% by mass) of all epoxy resins included in the epoxy resin composition, the content of the component (A) is, for example, preferably 40% to 70% by mass, more preferably 40% to 65% by mass, still more preferably 41% to 60% by mass, and even more preferably 42% to 55% by mass.

In a case where the content of the component (A) is the above-described lower limit value or more with respect to the total mass (100% by mass) of all epoxy resins included in the epoxy resin composition, the heat resistance of the resin cured product, the adhesiveness to carbon fiber, and the mechanical properties tend to be improved, and a fiber-reinforced composite resin molded article having both heat resistance and mechanical properties are obtained. In a case where the content of the component (A) is the above-described upper limit value or less with respect to the total mass (100% by mass) of all epoxy resins included in the epoxy resin composition, a prepreg having excellent tack and drape properties can be obtained, and a resin cured product having high breaking strain and having no voids tends to be obtained.

(Component (B))

The component (B) is a novolac epoxy resin.

Since the epoxy resin composition includes the component (B), it is possible to maintain good heat resistance of the resin cured product. In addition, fast-curing property of the epoxy resin composition is improved, and a prepreg which is cured in a short time even at a low temperature is obtained.

Examples of the component (B) include a phenol novolac epoxy resin, and a cresol novolac epoxy resin.

It is preferable that the component (B) has a structural unit derived from a structure represented by Formula (1), and from the viewpoint of heat resistance, it is more preferable that the component (B) has a structural unit derived from a structure represented by Formula (2).

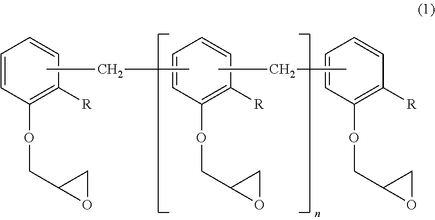

(in Formula (1), R represents a hydrogen atom, an alkyl group, an alkoxy group, or an aryl group, and n represents an integer of 1 to 30)

Examples of the alkyl group in R of Formula (1) include a methyl group, an ethyl group, an n-propyl group, and an isopropyl group, and a methyl group is preferable.

Examples of the alkoxy group in R of Formula (1) include a methoxy group and an ethoxy group, and a methoxy group is preferable.

Examples of the aryl group in R of Formula (1) include a phenyl group and a naphthyl group, and a phenyl group is preferable.

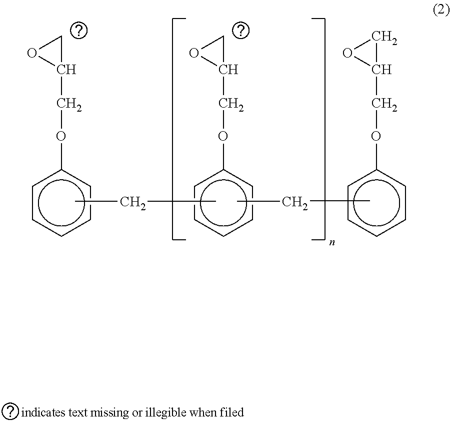

(in Formula (2), n represents an integer of 1 to 30)

Examples of a commercially available product of the phenol novolac epoxy resin include jER (registered trademark; the same applies hereinafter) 152 and 154 (both trade names, manufactured by Mitsubishi Chemical Corporation); and EPICLON (registered trademark; the same applies hereinafter) N-740 and N-775 (both trade names, manufactured by DIC CORPORATION).

Examples of a commercially available product of the cresol novolac epoxy resin include EPICLON N-660 and N-665 (both trade name, manufactured by DIC CORPORATION); EOCN-1020 and EOCN-102S (both trade names, manufactured by Nippon Kayaku Co., Ltd.); and YDCN-700 and YDCN-701 (both trade names, manufactured by Nippon Steel & Sumikin Chemical Co., Ltd.).

One kind of the component (B) may be used alone, or two or more kinds thereof may be used in combination.

With respect to the total mass (100% by mass) of all epoxy resins included in the epoxy resin composition, the content of the component (B) is 15% by mass or more, preferably 20% by mass or more. Further, with respect to the total mass (100% by mass) of all epoxy resins included in the epoxy resin composition, the content of the component (B) is 40% by mass or less, preferably 35% by mass or less and more preferably 30% by mass or less.

With respect to the total mass (100% by mass) of all epoxy resins included in the epoxy resin composition, the content of the component (B) is, for example, preferably 15% to 40% by mass, more preferably 15% to 35% by mass, still more preferably 20% to 35% by mass, and even more preferably 20% to 30% by mass.

In a case where the content of the component (B) is the above-described lower limit value or more with respect to the total mass (100% by mass) of all epoxy resins included in the epoxy resin composition, the heat resistance of the resin cured product tends to be improved, and a fiber-reinforced composite resin molded article having excellent heat resistance is obtained. In addition, the fast-curing property of the epoxy resin composition is improved, and a prepreg which is cured in a short time even at a low temperature is obtained. In a case where the content of the component (B) is the above-described upper limit value or less with respect to the total mass (100% by mass) of all epoxy resins included in the epoxy resin composition, the mechanical properties of the resin cured product tends to be improved, and a fiber-reinforced composite resin molded article having excellent mechanical properties is obtained. In addition, a resin cured product having high breaking strain and having no voids tends to be obtained. Further, it is possible to suppress an excessive increase in the viscosity of the epoxy resin composition, which facilitates the preparation of the epoxy resin composition.

From the viewpoint of heat resistance, the mass ratio of the content of the component (A) to the content of the component (B) (content of component (A)/content of component (B)) in the epoxy resin composition is preferably 1.2 or more and more preferably 1.6 or more.

From the viewpoint of toughness and strength, the mass ratio of the content of the component (A) to the content of the component (B) (content of component (A)/content of component (B)) in the epoxy resin composition is preferably 5.0 or less and more preferably 4.0 or less.

(Component (C))

The component (C) is a urea compound.

Since the epoxy resin composition includes the component (C), the fast-curing property of the epoxy resin composition is improved, and a prepreg which is cured in a short time even at a low temperature is obtained. In addition, deterioration of the mechanical properties including breaking strain of the resin cured product can be suppressed.

Examples of the urea compound include 3-phenyl-1,1-dimethylurea, 3-(3,4-dichlorophenyl)-1,1-dimethylurea (DCMU), 3-(3-chloro-4-methylphenyl)-1,1-dimethylurea, and 2,4-bis(3,3-dimethylureido)toluene.

From the viewpoint of achieving both toughness and strength, the urea compound is preferably phenyldimethylurea (PDMU).

Examples of a commercially available product of the urea compound include OMICURE (registered trademark; the same applies hereinafter) 24 (manufactured by PTI JAPAN Corporation) as 2,4-bis(3,3′-dimethylureaide) toluene (TBDMU); OMICURE 94 (manufactured by PTI JAPAN Corporation) as phenyldimethylurea (PDMU); OMICURE 52 and OMICURE 54 (manufactured by PTI JAPAN Corporation) as 4,4′-methylenebis(phenyldimethylurea) (MDMU); and DCMU 99 (manufactured by Hodogaya Chemical Co., Ltd.) as 3-(3,4-dichlorophenyl)-1,1-dimethylurea.

With respect to the total mass (100 parts by mass) of all epoxy resins included in the epoxy resin composition, the content of the component (C) is preferably 1 to 10 parts by mass and more preferably 2 to 8 parts by mass.

In a case where the content of the component (C) is the above-described lower limit value or more with respect to the total mass (100 parts by mass) of all epoxy resins included in the epoxy resin composition, a sufficient curing promoting function is obtained. In a case where the content of the component (C) is the above-described upper limit value or less with respect to the total mass (100 parts by mass) of all epoxy resins included in the epoxy resin composition, the storage stability of the epoxy resin composition is enhanced.

(Component (D))

The component (D) is a curing agent.

As the component (D), an amine curing agent is preferable. The amine curing agent is a particulate thermoactive latent curing agent, and is enable to cure at a relatively low temperature by being combined with other components. Further, since the amine curing agent has excellent dispersibility, the curing reaction speed is increased.

Examples of the amine curing agent include aromatic amines such as diaminodiphenylmethane and diaminodiphenylsulfone, aliphatic amines, imidazole derivatives, dicyandiamide, tetramethylguanidine, thiourea-added amines, and isomers and variants thereof. As the amine curing agent, from the viewpoint of excellent storage stability of the prepreg, dicyandiamide is particularly preferable.

One kind of these amine curing agents may be used alone, or two or more kinds thereof may be used in combination.

Examples of a commercially available product of the component (D) include DICYANEX (registered trademark; the same applies hereinafter) 1400F (trade name, manufactured by EVONIK Japan); and jERCURE (registered trademark) DICY 7 and DICY 15 (both trade names, manufactured by Mitsubishi Chemical Corporation).

With respect to the total mass (100 parts by mass) of all epoxy resins included in the epoxy resin composition, the content of the component (D) is preferably 2 to 15 parts by mass and more preferably 5 to 9 parts by mass.

In a case where the content of the component (D) is the above-described lower limit value or more with respect to the total mass (100 parts by mass) of all epoxy resins included in the epoxy resin composition, the curing reaction proceeds sufficiently. In a case where the content of the component (D) is the above-described upper limit value or less with respect to the total mass (100 parts by mass) of all epoxy resins included in the epoxy resin composition, the storage stability of the epoxy resin composition is enhanced, and physical properties of the resin cured product can be maintained well.

From the viewpoint of reactivity, the mass ratio of the content of the component (C) to the content of the component (D) (content of component (C)/content of component (D)) in the epoxy resin composition is preferably 0.2 or more and more preferably 0.4 or more.

From the viewpoint of storage stability, the mass ratio of the content of the component (C) to the content of the component (D) (content of component (C)/content of component (D)) in the epoxy resin composition is preferably 1.0 or less and more preferably 0.8 or less.

(Optional Component)

Examples of the optional component include an epoxy resin other than the component (A) and the component (B) (hereinafter, also referred to as an “other epoxy resins”), a thermoplastic resin, and an additive.

Examples of other epoxy resins include bifunctional epoxy resins such as a bisphenol A epoxy resin, a bisphenol F epoxy resin, and an epoxy resin modified from these epoxy resins; and trifunctional or higher functional epoxy resins such as a naphthalene epoxy resin, a glycidylamine epoxy resin, and an epoxy resin modified from these epoxy resins. However, other epoxy resins are not limited thereto.

One kind of these other epoxy resins may be used alone, or two or more kinds thereof may be used in combination.

Examples of a commercially available product of the bifunctional epoxy resin include the following.

Examples of a commercially available product of the bisphenol A epoxy resin include jER 825, 826, 827, 828, 834, and 1001 (all trade names, manufactured by Mitsubishi Chemical Corporation); EPICLON 850 (trade name, manufactured by DIC CORPORATION); Epotohto (registered trademark; the same applies hereinafter) YD-128 (trade name, manufactured by Nippon Steel & Sumikin Chemical Co., Ltd.); DER 331 and 332 (both trade names, manufactured by Dow Chemical Japan); and Bakelite (registered trademark, the same applies hereinafter) EPR 154, EPR 162, EPR 172, EPR 173, and EPR 174 (all trade names, manufactured by Bakelite AG).

Examples of a commercially available product of the bisphenol F epoxy resin include jER 806, 807, and 1750 (all trade names, manufactured by Mitsubishi Chemical Corporation); EPICLON 830 (trade name, manufactured by DIC CORPORATION); Epotohto YD-170 and YD-175 (both trade names, manufactured by Nippon Steel & Sumikin Chemical Co., Ltd.); Bakelite EPR 169 (trade name, manufactured by Bakelite AG); and GY 281, GY 282, and GY 285 (all trade names, manufactured by Huntsman International LLC.).

Examples of a commercially available product of the trifunctional or higher functional epoxy resin include the following.

Examples of a commercially available product of the naphthalene epoxy resin include HP-4032 and HP-4700 (all trade names, manufactured by DIC CORPORATION); and NC-7300 (trade name, manufactured by Nippon Kayaku Co., Ltd.).

Examples of a commercially available product of the glycidylamine epoxy resin include jER 630 (trade name, manufactured by Mitsubishi Chemical Corporation), Araldite (registered trademark) MY 0500, MY 0510, and MY 0600 (all trade names, manufactured by Huntsman International LLC.).

Examples of the thermoplastic resin include polyamide, polyester, polycarbonate, polyether sulfone, polyphenylene ether, polyphenylene sulfide, polyether ether ketone, polyether ketone, polyether imide, polyimide, polytetrafluoroethylene, polyether, polyolefin, liquid crystal polymer, polyarylate, polysulfone, polyacrylonitrile styrene, polystyrene, polyacrylonitrile, polymethylmethacrylate, acrylonitrile-butadiene-styrene copolymer (ABS resin), acrylonitrile-ethylene-propylene-diene-styrene copolymer (AES resin), acrylonitrile-styrene-alkyl(meth) acrylate copolymer (ASA resin), polyvinyl chloride, polyvinyl formal, phenoxy resin, and block polymer. The thermoplastic resin is not limited thereto.

One kind of these thermoplastic resins may be used alone, or two or more kinds thereof may be used in combination.

Among the above-described thermoplastic resins, from the viewpoint of excellent resin flow controllability and the like, phenoxy resin, polyether sulfone, polyether imide, polyvinyl formal, or block polymer is preferable.

In particular, in a case where a phenoxy resin, polyether sulfone, or polyether imide is used, the heat resistance and flame retardancy of the resin cured product are further enhanced. In a case of polyvinyl formal is used, the tack of the obtained prepreg can be easily controlled within an appropriate range without impairing the heat resistance of the resin cured product. In addition, the adhesiveness between the reinforcing fiber and the resin cured product is further enhanced. In a case where block polymer is used, the toughness and impact resistance of the resin cured product are improved.

Examples of a commercially available product of the phenoxy resin include YP-50, YP-50S, YP70, ZX-1356-2, and FX-316 (all trade names, manufactured by Nippon Steel & Sumikin Chemical Co., Ltd.). The commercially available product of the phenoxy resin is not limited thereto.

Examples of a commercially available product of the polyvinyl formal include VINYLEC (registered trademark) K (average molecular weight: 59,000), L (average molecular weight: 66,000), H (average molecular weight: 73,000), and E (average molecular weight: 126,000) (all trade names, manufactured by JNC Corporation). The commercially available product of the polyvinyl formal is not limited thereto.

In a case where it is required for the resin cured product to have heat resistance exceeding 180° C., polyether sulfone or polyether imide is preferably used as the thermoplastic resin.

Examples of a commercially available product of the polyether sulfone include SUMIKAEXCEL (registered trademark) 3600P (average molecular weight: 16,400), 5003P (average molecular weight: 30,000), 5200P (average molecular weight: 35,000), and 7600P (average molecular weight: 45,300) (all trade names, manufactured by Sumitomo Chemical Company).

Examples of a commercially available product of the polyether imide include ULTEM (registered trademark) 1000 (average molecular weight: 32,000), 1010 (average molecular weight: 32,000), and 1040 (average molecular weight: 20,000) (all trade names, manufactured by SABIC Innovative Plastics Japan). The commercially available product of the polyether imide is not limited thereto.

Examples of a commercially available product of the block polymer include Nanostrength (registered trademark) M52, M52N, M22, M22N, 123, 250, 012, E20, and E40 (all trade names, manufactured by Arkema); and TPAE-8, TPAE-10, TPAE-12, TPAE-23, TPAE-31, TPAE-38, TPAE-63, TPAE-100, and PA-260 (all trade names, manufactured by T&K TOKA Corporation). The commercially available product of the block polymer is not limited thereto.

Examples of the additive include a curing accelerator of the epoxy resin, an inorganic filler, an internal mold release agent, an organic pigment, and an inorganic pigment.

(Method for Producing Epoxy Resin Composition)

The epoxy resin composition can be obtained, for example, by mixing the above-described components.

Examples of a method for mixing each component include a method using a mixer such as a three-roll mill, a planetary mixer, a kneader, a homogenizer, and a homodisper.

The epoxy resin composition can be used for producing a prepreg by being impregnated into an aggregate of reinforcing fibers, for example, as described later. In addition, a film of the epoxy resin composition can be obtained by applying the epoxy resin composition to a release paper or the like and curing the epoxy resin composition.

The epoxy resin composition obtained as described above can be cured in a short time even at a low temperature. Specifically, the complete curing time of the epoxy resin composition tends to be 12 minutes or less.

Further, the viscosity of the epoxy resin composition at 30° C. tends to be 100 to 1,000,000 Pa·s, and the tack adjustment and workability of the prepreg surface are excellent.

Further, the cured product (resin cured product) of the epoxy resin composition is excellent in mechanical properties such as flexural modulus, bending strength and breaking strain, and excellent in heat resistance. For example, the flexural modulus of the cured product of the epoxy resin composition obtained by curing at 140° C. for 30 minutes tends to be 3.6 GPa or more, the bending strength thereof tends to be 174 MPa or more, and the breaking strain thereof tends to be 9% or more. Further, the glass transition temperature, which is an index of the heat resistance of the cured product of the epoxy resin composition obtained under the same conditions, tends to be 140° C. or higher.

In one embodiment, “low temperature” means a temperature of 100° C. to 140° C. Further, “short time” means 10 to 30 minutes.

<Reinforcing Fiber>

The reinforcing fiber exists as a reinforcing fiber base material (aggregate of reinforcing fibers) in the prepreg, and is preferably in a form of a sheet.

The reinforcing fiber may be those in which the reinforcing fibers are arranged in a single direction, or may be those in which the reinforcing fibers are arranged in a random direction.

Examples of the form of the reinforcing fiber include a woven fabric of reinforcing fibers, a non-woven fabric of reinforcing fibers, and a sheet in which long fibers of reinforcing fibers are aligned in one direction. From the viewpoint of being able to form fiber-reinforced composite material having high specific strength and specific elastic modulus, the reinforcing fiber is preferably a sheet formed of a bundle of reinforcing fibers in which long fibers are aligned in a single direction, and from the viewpoint of easy handling, the reinforcing fiber is preferably a woven fabric of reinforcing fibers.

Examples of a material of the reinforcing fiber include glass fiber, carbon fiber (including graphite fiber), aramid fiber, and boron fiber.

From the viewpoint of mechanical properties and weight reduction of the fiber-reinforced composite resin molded article, carbon fiber is preferable as the reinforcing fiber. That is, the reinforcing fiber is preferably a reinforcing fiber base material including carbon fiber.

The fiber diameter of the carbon fiber is preferably 3 to 12 μm.

In a case where the fiber diameter of the carbon fiber is the above-described lower limit value or more, in processes for processing carbon fibers, such as comb and roll, the carbon fibers are less likely to be cut or fluffed, in a case where the carbon fibers move laterally and rub against each other, or a case where the carbon fibers and the roll surface or the like rub against each other. Therefore, a fiber-reinforced composite material having stable strength can be suitably produced. In a case where the fiber diameter of the carbon fiber is the above-described upper limit value or less, the carbon fiber can be produced by a normal method.

The number of carbon fibers in the carbon fiber bundle is preferably 1,000 to 70,000.

From the viewpoint of rigidity of the fiber-reinforced composite resin molded article, the strand tensile strength of the carbon fiber is preferably 1.5 to 9 GPa, and the strand tensile elastic modulus of the carbon fiber is preferably 150 to 260 GPa.

The strand tensile strength and strand tensile elastic modulus of the carbon fiber are values measured in accordance with JIS R 7601:1986.

<Method for Producing Prepreg>

The prepreg can be obtained, for example, by impregnating an aggregate of reinforcing fibers with the above-described epoxy resin composition. The prepreg obtained as described above is an aggregate of reinforcing fibers impregnated with the epoxy resin composition.

Examples of a method of impregnating the aggregate of reinforcing fibers with the epoxy resin composition include a wet method in which the epoxy resin composition is dissolved in a solvent such as methyl ethyl ketone and methanol to reduce the viscosity thereof, and then impregnated into an aggregate of reinforcing fibers; and a hot melt method (dry method) in which the epoxy resin composition is heated to reduce the viscosity thereof, and then impregnated into an aggregate of reinforcing fibers. The method of impregnating the aggregate of reinforcing fibers with the epoxy resin composition is not limited thereto.

The wet method is a method in which an aggregate of reinforcing fibers is immersed in a solution of the epoxy resin composition and pulled up, and the solvent is evaporated using an oven or the like.

As the hot melt method, a method of directly impregnating an aggregate of reinforcing fibers with the epoxy resin composition that the viscosity has been reduced by heating, or a method in which the epoxy resin composition is once applied to a surface of a base material such as release paper to produce a film, the films are laminated from both sides or one side of an aggregate of reinforcing fibers, and then a resin is impregnated into the aggregate of reinforcing fibers by heating and pressurizing is used. The coating layer obtained by coating on the surface of the base material such as release paper may be used in the hot melt method as being uncured, or may be used in the hot melt method after the coating layer is cured.

According to the hot melt method, virtually no solvent remains in the prepreg, which is preferable.

With respect to the total mass (100% by mass) of the prepreg, the content of the epoxy resin composition in the prepreg (hereinafter, also referred to as a “resin content”) is preferably 15% to 50% by mass, more preferably 20% to 45% by mass, and still more preferably 25% to 40% by mass.

In a case where the resin content is the above-described lower limit value or more, sufficient adhesiveness between the reinforcing fiber and the epoxy resin composition can be ensured. In a case where the resin content is the above-described upper limit value or less, the mechanical properties of the fiber-reinforced composite resin molded article are further enhanced.

<Effect>

The prepreg of the embodiment described above includes the above-described epoxy resin composition and reinforcing fiber. The epoxy resin composition included in the prepreg of the embodiment can prevent a decrease in glass transition temperature and a decrease in curing rate.

Therefore, the prepreg of the embodiment can be cured in a short time even at a low temperature, and can obtain a fiber-reinforced composite resin molded article having excellent mechanical properties such as flexural modulus, bending strength, and breaking strain, and excellent heat resistance.

Further, by using the prepreg of the embodiment, the processing time can be shortened in the molding of the fiber-reinforced composite resin molded article, so that the fiber-reinforced composite resin molded article can be produced at low cost.

Furthermore, since the epoxy resin composition included in the prepreg of the embodiment has a controlled viscosity at 30° C., the prepreg of the embodiment is excellent in adjusting the tack on the surface of the prepreg and in workability.

[Fiber-Reinforced Composite Resin Molded Article]

The fiber-reinforced composite resin molded article of the embodiment is a cured product of a laminate in which two or more prepregs of the embodiment described above are laminated. That is, the fiber-reinforced composite resin molded article of the embodiment includes a cured product of the epoxy resin composition included in the prepreg, and reinforcing fibers.

The fiber-reinforced composite resin molded article can be obtained, for example, by a method in which two or more prepregs of the embodiment are laminated, and then the epoxy resin composition is heat-cured while applying pressure to the obtained laminate.

Examples of a method of molding the fiber-reinforced composite resin molded article of the embodiment include a press molding method, an autoclave molding method, a bagging molding method, a wrapping tape method, an internal pressure molding method, a sheet wrap molding method, and resin transfer molding (RTM), vacuum assisted resin transfer molding (VaRTM; vacuum resin impregnation producing method), filament winding, or resin film infusion (RFI), in which an epoxy resin composition is impregnated into a filament or preform of reinforcing fibers and cured to obtain a molded product. The method of molding the fiber-reinforced composite resin molded article of the embodiment is not limited to these molding methods.

The wrapping tape method is a method of molding a tubular fiber-reinforced composite resin molded article (fiber-reinforced composite resin tubular body) by winding the prepreg around a core metal such as a mandrel, and is preferably used in a case of producing a rod-shaped body such as a golf shaft and a fishing rod. More specifically, the wrapping tape method is a method in which the prepreg is wound around the mandrel, a wrapping tape formed of a thermoplastic film is wrapped around the outside of the prepreg so as to fix the prepreg apply pressure to the prepreg, and after the epoxy resin composition in the prepreg is heat-cured in an oven, the core metal is removed, thereby obtaining a fiber-reinforced composite resin tubular body.

The internal pressure molding method is a method that a preform in which the prepreg is wound around an internal pressure applying body such as a tube formed of a thermoplastic resin is set in a mold, and then a high-pressure gas is introduced into the internal pressure applying body to apply pressure, and at the same time, the mold is heated, thereby molding the fiber-reinforced composite resin molded article. The heating temperature is not particularly limited, but the molding time can be shorter as the temperature is higher, which is preferable. Specifically, the heating temperature is preferably 120° C. or higher and more preferably 140° C. or higher. However, in a case where the temperature is too high, it will take a very long time to lower the temperature of the mold, or in a case where the prepreg is set without lowering the temperature, curing may start and the epoxy resin composition may spread to every corner of the final molded product. This method is preferably used in a case of molding a complicated-shaped product such as a golf shaft, a bat, and a racket for tennis, badminton, and the like.

Since the fiber-reinforced composite resin molded article of the embodiment described above is a cured product of a laminate in which two or more prepregs of the embodiment are laminated, the fiber-reinforced composite resin molded article of the embodiment has excellent mechanical properties such as flexural modulus, bending strength, and breaking strain, and excellent heat resistance.

The fiber-reinforced composite resin molded article of the embodiment is suitably used for sports applications, general industrial applications, and aerospace applications. More specifically, in sports applications, the fiber-reinforced composite resin molded article of the embodiment is suitably used for golf shafts, fishing rods, rackets for tennis and badminton, sticks for hockey and the like, and ski poles. Furthermore, in general industrial applications, the fiber-reinforced composite resin molded article of the embodiment is suitably used for structural materials of moving bodies such as automobiles, ships, and railroad vehicles, drive shafts, leaf springs, wind turbine blades, pressure vessels, flywheels, paper rollers, roofing materials, cables, and repair reinforcing materials.

[Epoxy Resin Composition]

The epoxy resin composition in another embodiment, which is different from the epoxy resin composition used in the prepreg of the embodiment described above, will be described below.

The epoxy resin composition of the embodiment comprises an epoxy resin and a curing agent.

Examples of the epoxy resin included in the epoxy resin composition of the embodiment include the above-described component (A), the above-described component (B), and other epoxy resins exemplified above as an optional component. The epoxy resin included in the epoxy resin composition of the embodiment preferably includes the component (A) or the component (B) described above, and more preferably includes the component (A) and component (B) described above. The specific components, contents, preferred aspects, and the like of the component (A) and the component (B) in the epoxy resin composition of the embodiment are as described above.

In particular, the epoxy resin included in the epoxy resin composition of the embodiment preferably has a ring structure, and from the viewpoint of heat resistance, it is preferable to have a naphthalene structure, a dicyclopentadiene structure, or a structural unit derived from a structure represented by Formula (2).

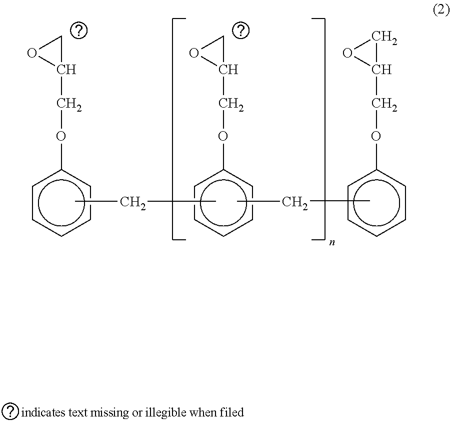

(in Formula (2), n represents an integer of 1 to 30)

Examples of the curing agent included in the epoxy resin composition of the embodiment include the above-described component (D). The specific components, contents, preferred aspects, and the like of the component (D) in the epoxy resin composition of the embodiment are as described above.

Since the fast-curing property of the epoxy resin composition is improved, a prepreg which is cured in a short time even at a low temperature is obtained, and a decrease in breaking strain of the resin cured product can be suppressed, the epoxy resin composition of the embodiment may include a urea compound. Examples of the urea compound include the above-described component (C). The specific components, contents, preferred aspects, and the like of the component (C) in the epoxy resin composition of the embodiment are as described above.

In the epoxy resin composition of the embodiment, the glass transition temperature, which is an index of the heat resistance of the cured product of the epoxy resin composition, is generally 120° C. or higher, preferably 130° C. or higher, more preferably 135° C. or higher, and still more preferably 140° C. or higher. Further, from the viewpoint of toughness, the glass transition temperature is preferably 250° C. or lower, more preferably 200° C. or lower, and still more preferably 180° C. or lower.

In a case where the epoxy resin composition of the embodiment is heated at 130° C. to 150° C. to obtain a cured resin plate, the curing completion time in the following measuring method is 12 minutes or less, preferably 11 minutes or less and more preferably 8 minutes or less.

(Measuring Method)

According to JIS K 6300, a change in torque value (N·m) at a die temperature of 140° C. is measured to obtain a torque-time curve. A time until an inclination of a tangent line of the obtained torque-time curve becomes 1/30 of the maximum value after the inclination reaches the maximum is defined as the curing completion time.

In the epoxy resin composition of the embodiment, the bending strength of the cured resin plate obtained by heating the epoxy resin composition at 130° C. to 150° C. is 174 MPa or more, preferably 175 MPa or more and more preferably 180 MPa or more, and from the viewpoint of cost, is preferably 250 MPa or less; the flexural modulus thereof is 3.6 GPa or more, preferably 3.7 GPa or more and more preferably 3.8 GPa or more, and from the viewpoint of cost, is preferably 5.0 MPa or less; and the breaking strain thereof is 9% or more, preferably 9.5% or more and more preferably 10% or more, and from the viewpoint of cost, is preferably 20% or less.

As described above, the epoxy resin composition of the embodiment can be cured in a short time even at a low temperature, and can obtain a resin molded article having excellent mechanical properties such as flexural modulus, bending strength, and breaking strain, and excellent heat resistance. Therefore, the epoxy resin composition of the embodiment is useful as a matrix resin used for prepreg.

[Method for Producing Tubular Molded Article]

The method for producing a tubular molded article of the embodiment comprises the following steps.

(1) step of placing a tubular prepreg including a resin composition and reinforcing fibers in a mold

(2) step of heating the tubular prepreg at 130° C. or higher

(3) step of pressing the tubular prepreg against the mold by expanding a medium from an inside of the tubular prepreg, thereby molding a tubular molded article

The tubular prepreg can be obtained by, for example, winding a prepreg including a resin composition and a reinforcing fiber around an internal pressure applying body such as a tube formed of a thermoplastic resin.

The obtained tubular prepreg is set in the mold and heated 130° C. or higher, preferably 140° C. or higher, to be molded. The molding can be performed by inflating the internal pressure applying body by introducing a high-pressure gas, and pressing the tubular prepreg against the mold from the inside of the tubular prepreg.

The resin composition included in the tubular prepreg used in the method for producing a tubular molded article of the embodiment includes the above-described component (A), component (B), and component (D). The specific components, contents, preferred aspects, and the like of the component (A), the component (B), and the component (D) in the method for producing a tubular molded article of the embodiment are as described above.

Since the fast-curing property of the resin composition is improved, a tubular prepreg which is cured in a short time even at a low temperature is obtained, and a decrease in breaking strain of the resin cured product can be suppressed, the resin composition included in the tubular prepreg used in the method for producing a tubular molded article of the embodiment may include a urea compound. Examples of the urea compound include the above-described component (C). The specific components, contents, preferred aspects, and the like of the component (C) in the method for producing a tubular molded article of the embodiment are as described above.

The resin composition included in the tubular prepreg used in the method for producing a tubular molded article of the embodiment may be the above-described epoxy resin composition of the embodiment, or may be the epoxy resin composition included in the above-described prepreg of the embodiment.

In the method for producing a tubular molded article of the embodiment, in a case where the tubular molded article has an annular curved portion, the method for producing a tubular molded article of the embodiment may further include a step of annularly bending the tubular prepreg.

The case where the tubular molded article has an annular curved portion refers to applications such as a racket for tennis or badminton.

[Tubular Molded Article]

The tubular molded article of the embodiment has a curved portion, preferably an annular curved portion, and includes a cured product of a resin composition and carbon fiber.

The resin composition included the tubular molded article of the embodiment includes the above-described component (A), component (B), and component (D). The specific components, contents, preferred aspects, and the like of the component (A), the component (B), and the component (D) in the method for producing a tubular molded article of the embodiment are as described above. That is, the resin composition included in the tubular molded article of the embodiment may have the same specific components, contents, preferred aspects, and the like as those in the resin composition included in the tubular prepreg used in the method for producing a tubular molded article of the embodiment.

### EXAMPLES

Hereinafter, the embodiment will be specifically described with reference to Examples, but the embodiment is not limited to these Examples.

<Each Component>

(Component (A))
TSR-400: oxazolidone epoxy resin (manufactured by DIC CORPORATION, trade name: TSR-400)

(Component (B))
N-775: phenol novolac epoxy resin (manufactured by DIC CORPORATION, trade name: EPICLON N-775)
N-740: phenol novolac epoxy resin (manufactured by D1C CORPORATION, trade name: EPICLON N-740)

(Component (C))
OMICURE 94: 3-phenyl-1,1-dimethylurea (manufactured by PTI JAPAN Corporation, trade name: OMICURE 94)

(Component (D))
1400F: dicyandiamide (manufactured by EVONIK Japan, trade name: DICYANEX 1400F)

(Other Epoxy Resins)
jER 807: bisphenol F epoxy resin (manufactured by Mitsubishi Chemical Corporation, trade name: jER 807)
jER 828: bisphenol A epoxy resin (manufactured by Mitsubishi Chemical Corporation, trade name: jER 828, number-average molecular weight: 370)
jER 828+DDS: epoxy resin obtained by mixing 100 parts by mass of bisphenol A epoxy resin (manufactured by Mitsubishi Chemical Corporation, trade name: jER 828, number-average molecular weight: 370) and 9 parts by mass of 4,4′-diaminodiphenyl sulfone (4,4′-DDS, manufactured by Wakayama Seika Kogyo Co., Ltd., trade name: SEIKACURE (registered trademark)-S) with each other, and heating the obtained mixture to 170° C. to be reacted for 1 hour (preliminary reaction) (epoxy equivalent: 266 g/eq, viscosity at 90° C.: 1.3 Pa·s)

(Other Components)
2MZA-PW: (manufactured by SHIKOKU CHEMICALS CORPORATION, trade name: CUREZOL 2MZA-PW)

### Examples 1 to 4 and Comparative Examples 1 to 8

<Production of Cured Resin Plate>

An epoxy resin composition was prepared as follows according to formulations shown in Tables 1 to 3.

First, components other than the component (C) and the component (D) were weighed in a glass flask, heated and mixed at 100° C. to obtain a uniform epoxy resin main agent.

The obtained epoxy resin main agent is cooled to 60° C., the component (C) and the component (D) are weighed and added thereto, and an epoxy resin composition was obtained by being uniformly dispersed by heating and mixing the mixture at 60° C.

Next, the obtained epoxy resin composition was cast by sandwiching the obtained epoxy resin composition with glass plates together with a 2 mm-thick Teflon (registered trademark; the same applies hereinafter) spacer, and heat-cured at 140° C. for 30 minutes, thereby obtaining a cured resin plate (cured product of the epoxy resin composition) having a thickness of 2 mm. The obtained cured resin plate was measured and evaluated as follows.

The results are shown in Tables 1 to 3.

### Comparative Example 9

An epoxy resin composition was prepared as follows according to formulations shown in Table 3.

First, components other than the component (C) and the component (D) were weighed in a glass flask, heated and mixed at 100° C. to obtain a uniform epoxy resin main agent.

The obtained epoxy resin main agent is cooled to 60° C., the component (C) and the component (D) are weighed and added thereto, and an epoxy resin composition was obtained by being uniformly dispersed by heating and mixing the mixture at 60° C.

Next, the obtained epoxy resin composition was cast by sandwiching the obtained epoxy resin composition with glass plates together with a 2 mm-thick Teflon spacer, and heat-cured at 70° C. for 10 minutes and at 140° C. for 40 minutes, thereby obtaining a cured resin plate (cured product of the epoxy resin composition) having a thickness of 2 mm. The obtained cured resin plate was measured and evaluated as follows.

The results are shown in Table 3.

(Evaluation of Curing Property)

According to JIS K 6300, a change in torque value (N·m) at a die temperature of 140° C. is measured under the measurement conditions shown below to obtain a torque-time curve. A time until an inclination of a tangent line of the obtained torque-time curve becomes 1/30 of the maximum value after the inclination reaches the maximum is defined as the curing completion time.
Measuring equipment: manufactured by JSR Trading Co., Ltd., product name: CURELASTOMETER7 P
Vibration frequency: 100 cpm
Vibration angle: ±¼°
Dice shape: WP-100

(Evaluation of Mechanical Properties)

The cured resin plate in each example was processed into a test piece having a length of 60 mm and a width of 8 mm. The obtained test piece was subjected to a three-point bending test under the following measurement conditions, thereby measuring the bending strength, flexural modulus, and breaking strain of the cured resin plate.
Measuring equipment: manufactured by INSTRON Inc., product name: INSTRON 5565
Jig: indenter R=3.2 mm, support R=1.6 mm, ratio of distance (L) between supports to thickness (d) of test piece (L/d)=16
Measurement environment: temperature: 23° C., humidity: 50% RH

(Evaluation of Heat Resistance)

The cured resin plate in each example was processed into a test piece having a length of 55 mm and a width of 12.5 mm. For the obtained test piece, the storage elastic modulus (G′) was measured under the measurement conditions shown below, log G′ was plotted against temperature, and the temperature at an intersection of an approximate straight line of flat area of log G′ and an approximate straight line of area where G was transferred was recorded as the glass transition temperature (G′-Tg).
Measuring equipment: manufactured by TA Instruments Japan, product name: RES-RDA
Frequency: 1 Hz
Temperature rise rate: 5° C./min

TABLE 1

| | | | | Example | | | |
|---|---|---|---|---|---|---|---|
| | | | | 1 | 2 | 3 | 4 |
| Composition | Epoxy | Component | TSR400 | 45 | 50 | 50 | 60 |
| of resin/ | resin | (A) | | | | | |
| parts by | | Component | N-775 | 20 | 30 | 20 | 20 |
| mass | | (B) | N-740 | | | | |
| | | Other | jER 807 | 35 | 20 | 30 | 20 |
| | | | jER 828 | | | | |
| | | | jER 828 + | | | | |
| | | | DDS | | | | |
| | Auxiliary | Component | OMICURE | 3 | 3 | 3 | 2.8 |
| | curing | (C) | 94 | | | | |
| | agent | Other | 2MZA-PW | | | | |
| | Curing | Component | 1400F | 6.8 | 6.8 | 6.5 | 6.3 |
| | agent | (D) | | | | | |

| | Curing completion time | 11.5 | 7.7 | 11.0 | 10.7 |
|---|---|---|---|---|---|
| | [min] | | | | |
| | Bending strength [Mpa] | 176 | 177 | 180 | 174 |
| Physical properties of | Flexural modulus [Gpa] | 3.7 | 3.7 | 3.8 | 3.6 |
| resin plate | Breaking strain [%] | 10.1 | 10.0 | 9.8 | 11.5 |
| | G′ − Tg [° C.] | 142 | 150 | 147 | 149 |

TABLE 2

| | | | | Comparative Example | | | |
|---|---|---|---|---|---|---|---|
| | | | | 1 | 2 | 3 | 4 |
| Composition | Epoxy | Component | TSR400 | | 50 | 30 | 35 |
| of resin/ | resin | (A) | | | | | |
| parts by | | Component | N-775 | 40 | | 20 | 20 |
| mass | | (B) | N-740 | | | | |
| | | Other | jER 807 | | 50 | 50 | 45 |
| | | | jER 828 | 20 | | | |
| | | | jER 828 + | 40 | | | |
| | | | DDS | | | | |
| | Auxiliary | Component | OMICURE | 4.8 | 3.2 | 3 | 3 |
| | curing | (C) | 94 | | | | |
| | agent | Other | 2MZA-PW | | | | |
| | Curing | Component | 1400F | 6 | 7 | 7.6 | 7.6 |
| | agent | (D) | | | | | |

| | | | | |
|---|---|---|---|---|
| Curing completion time | 4.46 | 19.65 | 12.9 | 11.3 |
| [min] | | | | |
| Bending strength [Mpa] | 180 | 172 | 177 | 180 |

| | | | | | |
|---|---|---|---|---|---|
| Physical properties of | Flexural modulus [Gpa] | 3.6 | 3.7 | 3.8 | 3.8 |
| resin plate | Breaking strain [%] | 7.8 | 11.8 | 12.2 | 11.4 |
| | G′ − Tg [° C.] | 161 | 131 | 136 | 135 |

TABLE 3

| | | | | Comparative Example | | | | |
|---|---|---|---|---|---|---|---|---|
| | | | | 5 | 6 | 7 | 8 | 9 |
| Composition | Epoxy | Component | TSR400 | 50 | 50 | 71 | 40 | 45 |
| of resin/ | resin | (A) | | | | | | |
| parts by | | Component | N-775 | 5 | 10 | | | |
| mass | | (B) | N-740 | | | 15 | 45 | 35 |
| | | Other | jER 807 | 45 | 40 | 10 | 12 | |
| | | | jER 828 | | | | | 20 |
| | | | jER 828 + | | | | | |
| | | | DDS | | | | | |
| | Auxiliary | Component | OMICURE | 3 | 3 | 2.7 | 2.8 | |
| | curing | (C) | 94 | | | | | |
| | agent | Other | 2MZA-PW | | | | | 4 |
| | Curing | Component | 1400F | 6.8 | 6.8 | 6.3 | 7.6 | 2 |
| | agent | (D) | | | | | | |

| | | | | | |
|---|---|---|---|---|---|
| Curing completion time | 14.6 | 13.7 | 9.0 | 7.8 | 3.0 |
| [min] | | | | | |
| Bending strength [Mpa] | 164 | 167 | 169 | 171 | 143 |

| | | | | | | |
|---|---|---|---|---|---|---|
| Physical properties of | Flexural modulus [Gpa] | 3.5 | 3.5 | 3.7 | 3.6 | 3.5 |
| resin plate | Breaking strain [%] | 13.8 | 13.4 | 12.7 | 10.9 | 7.7 |
| | G′ − Tg [° C.] | 130 | 136 | 139 | 147 | 178 |

All of the epoxy resin compositions obtained in Examples 1 to 4 had a curing completion time of 12 minutes or less. Further, the cured resin plate, which is a cured product of these epoxy resin compositions, had a bending strength of 174 MPa or more, a flexural modulus of 3.6 GPa or more, and a breaking strain of 9% or more, and the mechanical properties thereof were excellent. Further, the glass transition temperature of the cured resin plate was 140° C. or higher, and the heat resistance thereof was also excellent.

Therefore, it was shown that the prepregs including the epoxy resin compositions obtained in Examples 1 to 4 could be cured in a short time even at a low temperature, and could obtain a fiber-reinforced composite resin molded article having excellent mechanical properties such as flexural modulus, bending strength, and breaking strain, and excellent heat resistance.

The epoxy resin composition of Comparative Example 1, which did not include the component (A), had low breaking strain of the cured product (cured resin plate), and the mechanical properties thereof were inferior.

The epoxy resin composition of Comparative Example 2, which did not include the component (B), had a long curing completion time. Further, the cured product of the epoxy resin composition had a low glass transition temperature and was inferior in heat resistance.

The cured products of the epoxy resin compositions of Comparative Examples 3 and 4, in which the content of the component (A) was less than 40% by mass, had a low glass transition temperature and were inferior in heat resistance. Further, since the content of the component (A) was small, it is presumed that the adhesiveness to the reinforcing fiber was lowered and the physical properties of the fiber-reinforced composite resin molded article were lowered.

The cured products of the epoxy resin compositions of Comparative Examples 5 and 6, in which the content of the component (B) was less than 15% by mass, had a low glass transition temperature and were inferior in heat resistance.

The cured product of the epoxy resin compositions of Comparative Example 7, in which the content of the component (A) was more than 70% by mass, had a low glass transition temperature and was inferior in heat resistance. Further, the bending strength of the cured product was low, and the mechanical properties thereof were inferior.

The cured product of the epoxy resin compositions of Comparative Example 8, in which the content of the component (B) was more than 40% by mass, had a low bending strength and was inferior in mechanical properties.

The epoxy resin composition of Comparative Example 9, which did not include the component (C), had low bending strength, flexural modulus, and breaking strain, and was inferior in mechanical properties.

### INDUSTRIAL APPLICABILITY

According to the prepreg of the embodiment, it is possible to be cured in a short time even at a low temperature, and to obtain a fiber-reinforced composite resin molded article having excellent mechanical properties such as flexural modulus, bending strength, and breaking strain, and excellent heat resistance. Therefore, according to the embodiment, it is possible to provide a wide range of molded bodies having high productivity, high efficiency, and excellent mechanical properties, for example, molded bodies for sports/leisure applications such as shafts for golf clubs, and molded bodies for industrial applications such as aircraft.

1. A prepreg comprising:
an epoxy resin composition; and
a reinforcing fiber,
wherein the epoxy resin comprises an oxazolidone epoxy resin, a novolac epoxy resin, a urea compound, and a curing agent,
with respect to a total mass of all epoxy resins included in the epoxy resin composition, a content of the oxazolidone epoxy resin is 40% to 70% by mass and a content of the novolac epoxy resin is 15% to 40% by mass.

2. The prepreg according to claim 1, wherein a mass ratio of the content of the oxazolidone epoxy resin to the content of the novolac epoxy resin (oxazolidone epoxy resin/novolac epoxy resin) in the epoxy resin composition is 1.2 or more.

3. The prepreg according to claim 1, wherein the novolac epoxy resin has a structural unit derived from a structure represented by Formula (2), 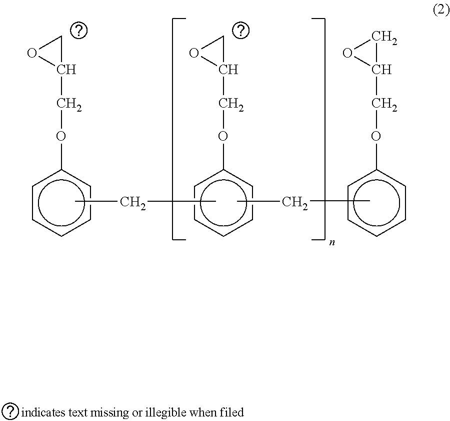
wherein in Formula (2), n represents an integer of 1 to 30.

4. The prepreg according to claim 1, wherein the reinforcing fiber comprises a carbon fiber.

5. The prepreg according to claim 1, wherein the curing agent comprises an amine curing agent.

6. The prepreg according to claim 5, wherein the amine curing agent includes diaminodiphenylmethane, diaminodiphenylsulfone, aliphatic amines, imidazole derivatives, dicyandiamide, tetramethylguanidine, thiourea-added amines, or isomers or variants thereof.

7. The prepreg according to claim 1, wherein the urea compound comprises phenyldimethylurea.

8. The prepreg according to claim 1, wherein a content of the urea compound is 1 to 10 parts by mass with respect to the total mass of all epoxy resins in the epoxy resin composition.

9. The prepreg according to claim 1, wherein a content of the curing agent is 2 to 15 parts by mass with respect to the total mass of all epoxy resins in the epoxy resin composition.

10. The prepreg according to claim 1, wherein the epoxy resin composition further comprises a bisphenol F epoxy resin.

11. A fiber-reinforced composite resin molded article, which is a cured product of a laminate in which two or more prepregs each of which is the prepreg according to claim 1 are laminated.

12. A method for producing a tubular molded article, comprising:
placing a tubular prepreg including a resin composition and a reinforcing fiber in a mold;
heating the tubular prepreg at 130° C. or higher; and
pressing the tubular prepreg against the mold by expanding a medium from an inside of the tubular prepreg, thereby molding a tubular molded article,
wherein the resin composition includes an oxazolidone epoxy resin, a novolac epoxy resin, and a curing agent.

13. The method for producing the tubular molded article according to claim 12,
wherein the tubular molded article has an annular curved portion, and
the method for producing the tubular molded article further includes annularly bending the tubular prepreg.

14. An epoxy resin composition comprising:
an epoxy resin; and
a curing agent,
wherein a glass transition point of the epoxy resin composition is 140° C. or higher in a case where the epoxy resin composition is heated at 130° C. to 150° C. to obtain a cured resin plate, a curing completion time in the following measuring method is 12 minutes or less:
according to JIS K 6300, in which a change in torque value (N·m) at a die temperature of 140° C. is measured to obtain a torque-time curve; and a time until an inclination of a tangent line of the obtained torque-time curve becomes 1/30 of a maximum value after the inclination reaches the maximum is defined as the curing completion time, and
the cured resin plate has a bending strength of 174 MPa or more, a flexural modulus of 3.6 GPa or more, and a breaking strain of 9% or more.

15. The epoxy resin composition according to claim 14, wherein the epoxy resin has a ring structure.

16. The epoxy resin composition according to claim 14, wherein the epoxy resin has a structural unit derived from a structure represented by Formula (2), 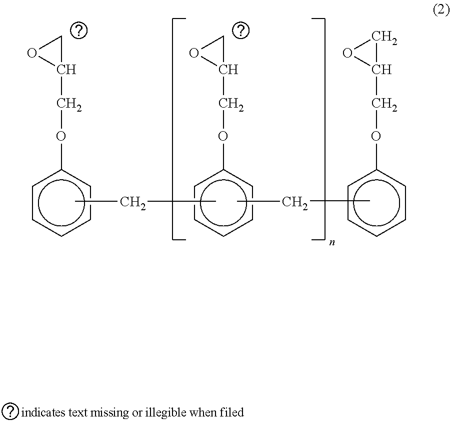
wherein in Formula (2), n represents an integer of 1 to 30.

17. The epoxy resin composition according to claim 14, wherein the epoxy resin includes a urea compound.

18. The epoxy resin composition according to claim 17, wherein the urea compound comprises phenyldimethylurea.

19. The prepreg according to claim 18, wherein the epoxy resin composition further comprises a bisphenol F epoxy resin.
